(19) United States
(12) Patent Application Publication
(10) Pub. No.: US 2007/0024460 A1
(43) Pub. Date: Feb. 1, 2007

(54) ELECTRICAL APPARATUS WITH VOLTAGE DROP INDICATOR

(76) Inventor: Richard Lee Clark, Burlington, NC (US)

Correspondence Address: ADAMS EVANS P.A., 301 SOUTH TRYON STREET, SUITE 2180, TWO WACHOVIA CENTER, CHARLOTTE, NC, 28282-1991, US

(21) Appl. No.: 11/460,752

(22) Filed: Jul. 28, 2006

Related U.S. Application Data
(60) Provisional application No. 60/595,732, filed on Aug. 1, 2005.

(51) Int. Cl. G08B 21/00

(52) U.S. Cl. 340/663

(57) ABSTRACT

An electrical apparatus has an indicator for indicating a voltage drop across an electrical system. The electrical apparatus includes a core, a sense lead, and an indicator. The core transmits electrical current from a source to a load. The sense lead electrically connects to the core for sensing a voltage drop between a source end and a sink end of the core. The indicator is operably connected to the sense lead and provides an indication when the voltage drop exceeds a predetermined limit.

### CROSS-REFERENCE TO RELATED APPLICATIONS

This application claims the benefit of Provisional Application No. 60/595,732 filed on Aug. 1, 2005.

### TECHNICAL FIELD AND BACKGROUND OF THE INVENTION

The present invention relates to the field of electrical systems. In particular, the invention relates to an electrical apparatus having an indicator for indicating a voltage drop across an electrical system.

In transmitting an electrical current from the power source to the electrical load, it is desirable to supply a current free of distortion and with a minimal voltage drop. In many electrical systems, minimizing voltage drop is very important to the proper operation of the system. This voltage drop usually occurs in the electrical cables and electrical connectors used to electrically connect the power source and load. If the voltage drop exceeds a predetermined limit, the system will not operate correctly and the system could be damaged.

For example, in many contemporary mobile audio systems, power amplifiers are connected to the car's battery and charging system via electrical cables. Due to variations in program material, power amplification, load conditions, and wiring or power block configurations, excessive voltage drop across the cables can affect performance. With inadequate cables and connectors, a voltage drop occurs as a result of resistive and/or inductive losses. This voltage drop can manifest itself in degraded audio performance, and in many instances, vehicle performance, as well. For example, inadequate current for the audio system may result in audio distortion and otherwise less than optimal performance. Inadequate vehicle current may result in headlights dimming, rough idling, and charging errors. Thus, minimizing the voltage drop across the cable increases audio performance and reduces the load on the vehicle's electrical system.

One of the methods used to minimize distortion and voltage drop across the cable is to use a cable having a highly conductive, low resistance core, but even with these features the cable must be properly sized to minimize voltage drop.

One method of sizing a cable for a particular application is to refer to a chart that estimates the proper cable size based on various parameters such as the length of cable being used and the voltage being supplied to the cable by a power source. The disadvantage of this method is that the charts are mere estimates that do not provide an accurate indication of voltage drop in a particular cable or electrical system. Another method is to use a voltage tester to measure the voltage drop across the cable, but this method requires the purchase of additional equipment and requires an individual to measure the voltage and, in any event, measuring voltage at a particular load may not provide an accurate reflection of system operation under a wide variety of circumstances.

Accordingly, there is a need for an electrical apparatus with a voltage drop indicator that is capable of continuously monitoring and accurately indicating when an undesired voltage drop is occurring across the cables and connectors of an electrical system.

### SUMMARY OF THE INVENTION

Therefore, it is an object of the invention to provide an electrical cable capable of visually or audibly indicating a voltage drop.

It is another object of the invention to provide an electrical cable having an insulated sense lead embedded in the cable.

It is another object of the invention to provide an electrical cable that has an indicator for indicating a voltage drop.

It is another object of the invention to provide a power distribution block that is capable of visually or audibly indicating a voltage drop.

It is another object of the invention to provide a component such as an amplifier with sense lead terminals for electrically connecting a sense lead directly to the amplifier.

It is another object of the invention to provide an indicator that can be remotely located.

These and other objects of the present invention are achieved in the preferred embodiments disclosed below by providing an electrical apparatus with voltage drop indication. The electrical apparatus includes a core, a sense lead, and an indicator. The core transmits electrical current from a source to a load. The sense lead is electrically connected to the core for sensing a voltage drop between a source end and a sink end of the core. The indicator is operably connected to the sense lead for indicating an undesired voltage drop between the source end and the sink end.

According to another preferred embodiment of the invention, the sense lead includes a core for transmitting electrical current and an insulation layer for covering the core.

According to another preferred embodiment of the invention, at least a portion of the sense lead is embedded in the core.

According to another preferred embodiment of the invention, the indicator provides a visual indication of the undesired voltage drop.

According to another preferred embodiment of the invention, the indicator provides an audible indication of the undesired voltage drop.

According to another preferred embodiment of the invention, the indicator is a light emitting diode.

According to another preferred embodiment of the invention, the indicator is located remote of the core.

According to another preferred embodiment of the invention, the source end of the core is electrically connected to the source and the sink end is electrically connected to the load.

According to another preferred embodiment of the invention, when a voltage drop occurs between the source end and the sink end, current representative of the voltage drop is transmitted through the sense lead to the indicator.

According to another preferred embodiment of the invention, when the voltage drop reaches an undesired level the indicator activates to provide an indication of the voltage drop.

According to another preferred embodiment of the invention, an electrical apparatus with voltage drop indication includes at least one input terminal for being electrically connected to a source; at least one output terminal electrically connected to the at least one input terminal for being electrically connected to a load; at least one sense lead electrically connected to a respective one of the input and output terminals for sensing a voltage drop; and at least one indicator operably connected to the at least one sense lead for indicating an undesired voltage drop.

According to another preferred embodiment of the invention, further including at least one sense lead terminal for electrically connecting the at least one sense lead to a respective one of the input and output terminals.

According to another preferred embodiment of the invention, the at least one indicator is attached to the at least one sense lead.

According to another preferred embodiment of the invention, the at least one indicator is integrally-formed in the electrical apparatus.

According to another preferred embodiment of the invention, the at least one sense lead is fixedly attached to a respective one of the input and output terminals.

According to another preferred embodiment of the invention, the at least one sense lead is electrically connected between the at least one input terminal and the source to sense a voltage drop.

According to another preferred embodiment of the invention, when a voltage drop occurs between the source and the input terminal, current representative of the voltage drop is transmitted through the sense lead to the indicator.

According to another preferred embodiment of the invention, further including at least one fuse electrically connecting the input terminal to the output terminal for providing a disconnect in the event of a surge.

According to another preferred embodiment of the invention, an electrical apparatus with voltage drop indication includes at least one input terminal for being electrically connected to a source; at least one output terminal electrically connected to the at least one input terminal for being electrically connected to a load; at least one indicator electrically connected to a respective one of the input and output terminals and fixedly attached to the electrical apparatus for indicating an undesired voltage drop; and at least one sense lead electrically connected to the indicator for sensing a voltage drop and transmitting a current representative of the voltage drop to the indicator.

According to another preferred embodiment of the invention, further including at least one sense lead terminal for electrically connecting the at least one sense lead to a respective one of the input and output terminals.

According to another preferred embodiment of the invention, the at least one sense lead is fixedly attached to a respective one of the input and output terminals.

According to another preferred embodiment of the invention, the at least one sense lead is electrically connected between the at least one input terminal and the source to sense a voltage drop.

According to another preferred embodiment of the invention, the at least one sense lead is electrically connected between the at least one output terminal and the load to sense a voltage drop.

According to another preferred embodiment of the invention, an audio system includes a power source; an amplifier electrically connected to the power source for amplifying a signal; a speaker electrically connected to the amplifier for receiving the signal and producing an audible sound; and an electrical cable for electrically connecting the power source to the amplifier. The electrical cable includes a core for transmitting current from the power source to the amplifier; a sense lead at least partially embedded in the core for receiving a current representative of a voltage drop across the core; a voltage drop indicator electrically connected to the sense lead for receiving the current in the sense lead and indicating an undesired voltage drop; and an insulated cover for covering the core.

According to another preferred embodiment of the invention, an audio system includes a power source, and an amplifier electrically connected to the power source. The amplifier includes at least one input terminal for being electrically connected to the power source; at least one output terminal electrically connected to the input terminal; and at least one sense lead terminal electrically connected to the input terminal. The audio system further including at least one speaker electrically connected to the at least one output terminal for receiving a signal therefrom; and a plurality of electrical cables for electrically connecting the power source to the at least one input terminal and the amplifier to the at least one speaker.

According to another preferred embodiment of the invention, the amplifier includes at least one voltage drop indicator electrically connected to the at least one input terminal for indicating an undesired voltage drop.

According to another preferred embodiment of the invention, further including a sense lead electrically connected between the power source and the at least one amplifier to detect a voltage drop in an electrical cable electrically connecting the power source to the at least one input terminal.

According to another preferred embodiment of the invention, further including a sense lead electrically connected between the power source and the at least one sense lead terminal for transmitting a current representative of a voltage drop across an electrical cable electrically connecting the power source to the at least one input terminal to the indicator.

According to another preferred embodiment of the invention, further including a plurality of amplifiers. The amplifiers including at least one input terminal for being electrically connected to the power source; at least one output terminal electrically connected to the input terminal; and at least one sense lead terminal electrically connected to the input terminal.

According to another preferred embodiment of the invention, further including a power distribution block for distributing current from the power source to each of the plurality of amplifiers.

According to another preferred embodiment of the invention, the power distribution block includes at least one input terminal for electrically connecting to the power source; and a plurality of output terminals for electrically connecting to the plurality of amplifiers.

According to another preferred embodiment of the invention, the power distribution block includes a sense lead for each of the input and output terminals to detect a voltage drop between the power source and the power distribution block and the power distribution block and the plurality of amplifiers.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a schematic of a prior art mobile audio system;

FIG. 2 is a perspective view of an electrical cable according to an embodiment of the invention;

FIG. 3 is a cross-section of the electrical cable of FIG. 2;

FIG. 4 is a schematic of a mobile audio system using the electrical cable of FIG. 2;

FIG. 5 is a schematic of the mobile audio system of FIG. 4 with a remotely located indicator;

FIG. 6 is a schematic of a prior art multi-amplifier mobile audio system;

FIG. 7 is a power distribution block according to an alternative embodiment of the invention;

FIG. 8 is an electrical schematic of the power distribution block of FIG. 7;

FIG. 9 is a schematic of a multi-amplifier mobile audio system using the power distribution block of FIG. 7;

FIG. 10 is an amplifier according to another embodiment of the invention; and

FIG. 11 is a schematic of a mobile audio system using the amplifier of FIG. 10.

### DESCRIPTION OF THE PREFERRED EMBODIMENT AND BEST MODE

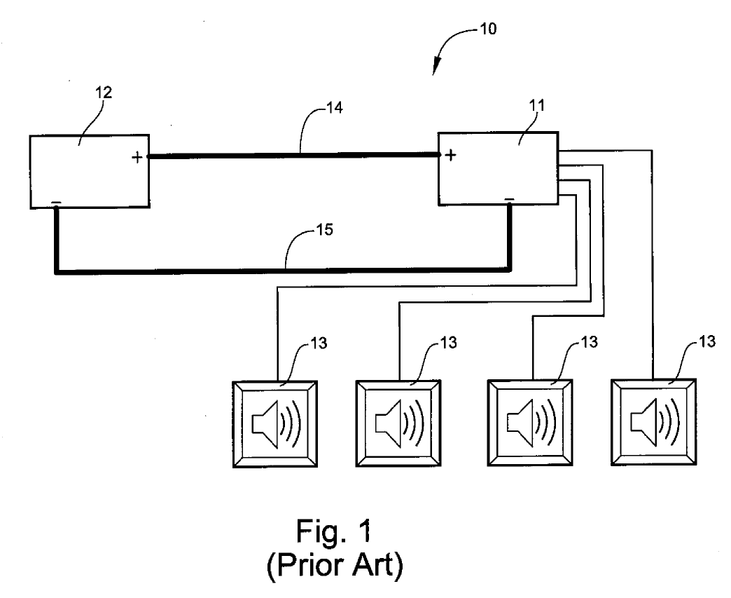

Referring now specifically to the drawings, a typical prior art mobile audio system is illustrated in FIG. 1 and shown generally at reference numeral 10. The audio system 10 includes an electrical load, such as a power amplifier 11, electrically connected to a power source, such as a battery 12, and a plurality of speakers 13 electrically connected to the amplifier 11. An electrical cable 14 (“power cable”) electrically connects a positive terminal of the battery 12 to a positive terminal of the amplifier 11, and an electrical cable 15 (“ground cable”) electrically connects a negative terminal of the battery 12 to a negative terminal of the amplifier 11. While this discussion is limited to a mobile audio system for illustrative purposes, the present invention is applicable to any electrical system where the voltage drop across an electrical cable or system is of concern, or where constant voltage monitoring is necessary or desirable.

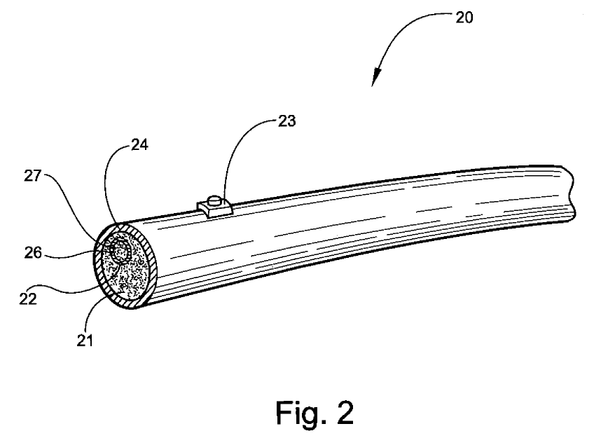

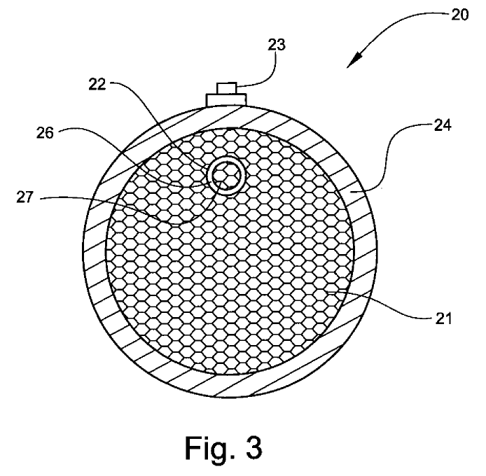

Referring to FIGS. 2 and 3, an electrical cable according to an embodiment of the invention is shown generally at reference numeral 20. The cable 20 includes a conducting core 21 for transmitting an electrical current, an insulated sense lead 22 electrically connected to the core 21, a voltage drop indicator 23 electrically connected to the sense lead 22, and an insulation layer 24 for covering the core 21. The sense lead 22 includes an insulation layer 26 and a conducting core 27. The sense lead 22 and core 21 may be electrically connected at a terminal, such as a battery terminal, or by directly connecting the core 27 to the core 21 at the ends of the cable 20. As illustrated, the sense lead 22 is embedded in the core 21, however, the sense lead 22 may also be positioned outside of the core 21, so long as the core 21 and sense lead 22 are electrically connected.

The cable 20 can be manufactured in various sizes to meet the requirements of an audio system. For example, the core 21 may be a No. 4 or a No. 8 American Wire Gauge (AWG) stranded cable. Likewise, the sense lead 22 may be of varying sizes depending on the size of the core 21. For example, if the core 21 is a No. 4 AWG stranded cable then a No. 30 AWG stranded sense lead 22 could be used to supply a voltage to the indicator 23.

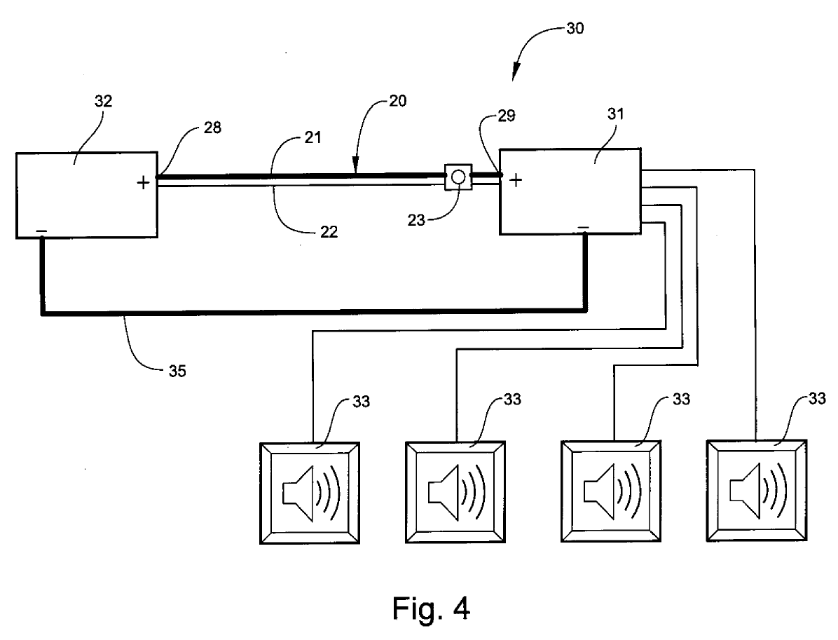

Referring to FIG. 4, a mobile audio system 30 is shown using the cable 20. Like the audio system 10, the audio system 30 includes a power source, such as a battery 32, an electrical load, such as an amplifier 31, a plurality of speakers 33, and a ground cable 35. As shown, the cable 20 replaces the power cable 14 shown in FIG. 1, but may also be used as a ground cable. The cable 20 electrically connects a positive terminal of the battery 32 to a positive terminal of the amplifier 31. A source end 28 of the sense lead 22 connects directly to the positive terminal of the battery 32, and a sink end 29 of the sense lead 22 connects directly to the positive terminal of the amplifier 31. The indicator 23 may be positioned at either the source 24 or the sink end 25, or indicators 23 may be positioned at both the source 24 and the sink end 25.

The sense lead 22 determines the voltage drop across the cable 20 by measuring the voltage difference between the source end 28 and the sink end 29 of the sense lead 22. If the voltage at the source end 28 is equal to the voltage at the sink end 29, then no current will flow through the sense lead 22. If the voltage at the source end 28 differs from the voltage at the sink end 29, then a current with a voltage representative of the voltage drop will flow through the sense lead 22 to the indicator 23. If the voltage drop exceeds a predetermined limit, the indicator 23 will provide a visual or audible indication that an undesired voltage drop exists. For a mobile audio system, a desired limit may be about 10 percent of the total supply voltage. Thus, for a 12 volt DC system, an LED having a 1.5 volt DC operating supply requirement would be an acceptable indicator 23. If the voltage drop is 1.5 volts or greater, the LED will illuminate and provide an indication that the voltage drop has exceeded the desired limit. Other types of indicators may also be used. For example, the indicator 23 may include active circuitry to drive other displays such as buzzers, bar graphs, peak holding or memory circuits, and analog to digital converters for monitoring by computer. The indicator 23 may also be an audible voice. For example, the indicator 23 may announce “Warning, Excessive Voltage Drop on Power Lead.”

This is particularly useful in sizing the cable 20 for use in the audio system 30. For example, if the cable 20 is inadequately sized for the audio system, a voltage drop exceeding 10 percent of the supply voltage will occur. The indicator 23 will then provide an indication to a user that the voltage drop has exceeded 10 percent of the supply voltage, thereby prompting the user to replace the cable 20 with a larger electrical cable. If the cable 20 is adequately sized and the voltage drop is less than 10 percent of the supply voltage, no indication will be given by the indicator 23. In addition to indicating cable size, the indicator 23 may be used to indicate a deteriorating connection or a faulty cable. Thus, the indicator 23 not only indicates that the audio system 30 has been installed correctly, but it also provides continuous monitoring of the audio system 30. This provides assurance that the audio system 30 and any system additions are performing properly.

Alternatively, the amplifier 31 may be grounded to a chassis of a vehicle instead of the battery 32. If this is done, the cable 20 may be electrically connected between the negative terminal of the battery 32 and the negative terminal of the amplifier 31. This configuration allows the sense lead 22 to detect a voltage drop in the chassis, thereby providing an indication that the chassis of the vehicle is inadequate as a conductor. This could be the result of corroded connectors, a bad connection point, or too many connectors for the capacity of the circuit.

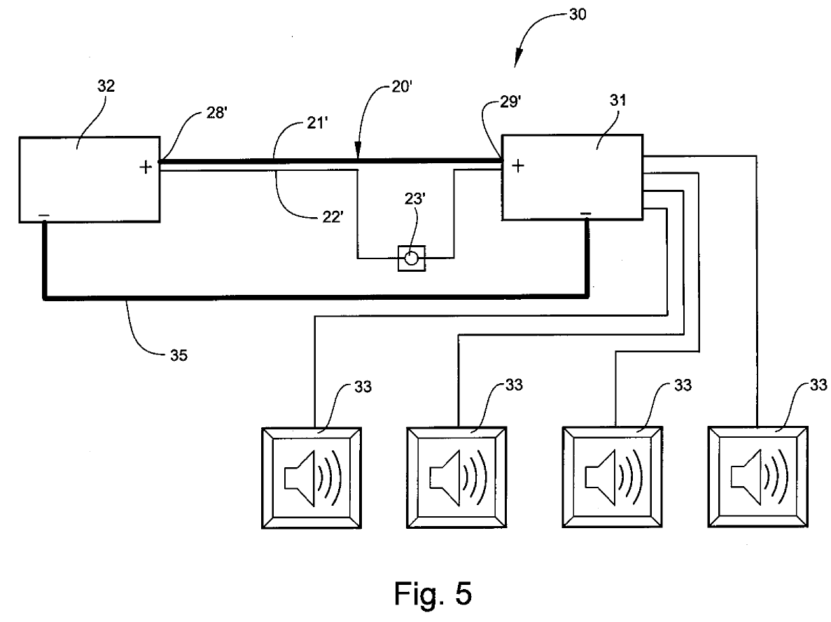

Referring to FIG. 5, an alternative electrical cable 20′ is used in the mobile audio system 30. Like the electrical cable 20, cable 20′ includes a core 21′, a sense lead 22′ having a source end 28′ and a sink end 29′, and a voltage drop indicator 23′. As shown, the sense lead 22′ allows the indicator 23′ to be remotely located in a location such as a trunk, head-liner, center console, and front dash of a vehicle. As illustrated, this is done by providing a sense lead 22′ with an extended length to allow the indicator 23′ to be positioned away from the cable 20′. Alternatively, this may be done by wireless transmission from the indicator 23′ to a display mounted in a remote location.

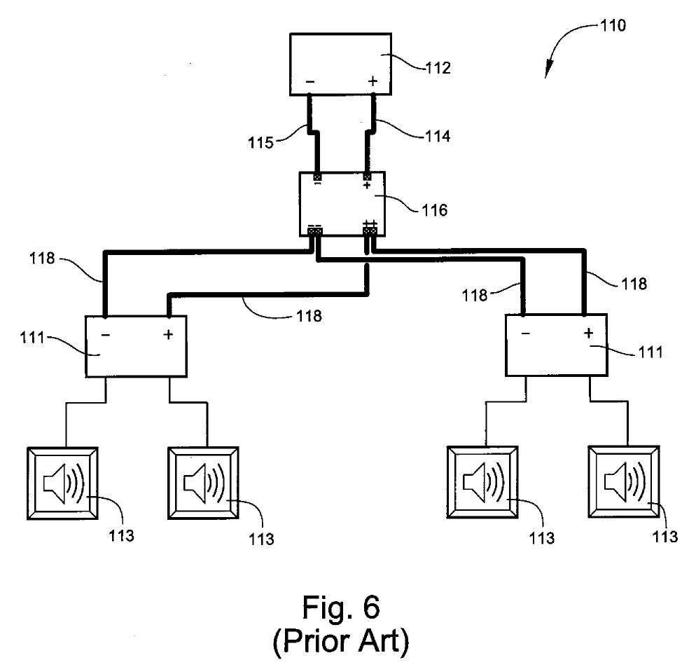

A prior art multi-amplifier mobile audio system is illustrated in FIG. 6 and shown generally at reference numeral 110. The audio system 110 includes a plurality of amplifiers 111 electrically connected to a battery 112 via a power distribution block 116, such as those that are commercially available, and a plurality of speakers 113 electrically connected to the amplifiers 111. As shown, the power distribution block 116 is electrically connected to the battery 112 by a power cable 114 and a ground cable 115. The power distribution block 116 distributes the current provided by the battery 112 to the amplifiers 111 via cables 118.

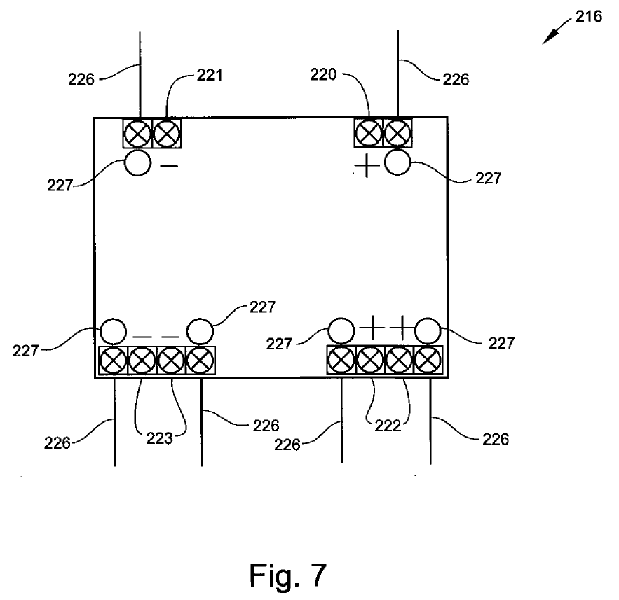

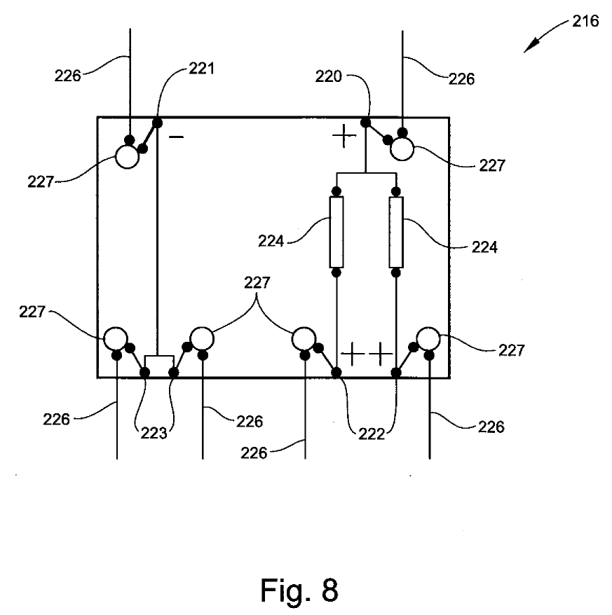

Referring to FIGS. 7 and 8, a power distribution block according to a further embodiment of the invention is shown generally at reference numeral 216. The power distribution block 216 includes a positive input terminal 220, a negative input terminal 221, a plurality of positive output terminals 222, and a plurality of negative output terminals 223. As illustrated in FIG. 8, the power distribution block 216 may also include a plurality of fuses 224 positioned between the positive input terminal 220 and the plurality of positive output terminals 222 to protect against an electrical surge. One or more insulated sense leads 226 are electrically connected to selected ones of the input terminals 220, 221 and output terminals 222, 223 and to corresponding voltage drop indicators 227. The sense leads 226 may be permanently attached to the power distribution block 216 or connected to the power distribution block 216 via a connector. The voltage drop indicators 227 may be attached to the sense lead 226, attached to or integrally-formed with the power distribution block 216, or remotely located in a location such as the dash of a vehicle. As illustrated, a plurality of indicators 227 are attached to or integrally-formed with the power distribution block 216, each being electrically connected to a respective one of the input 220, 221 and output terminals 222, 223.

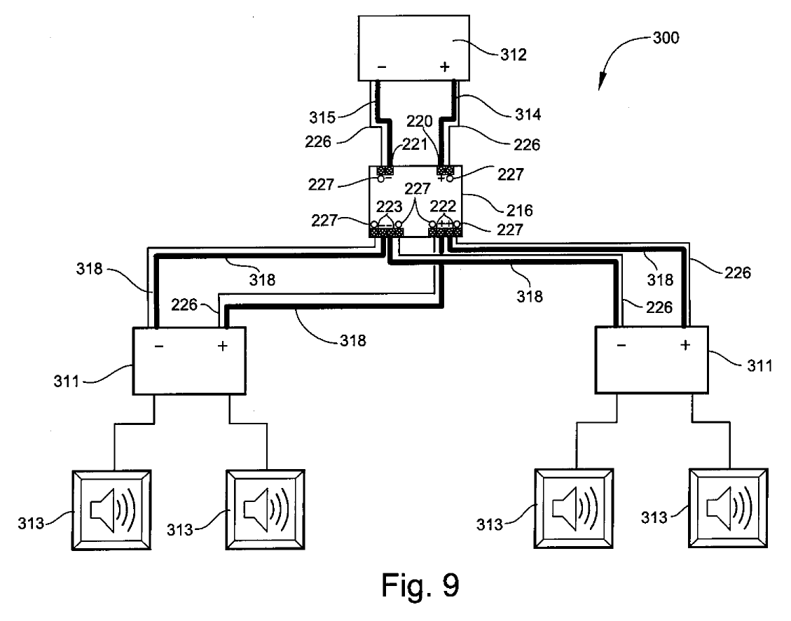

Referring to FIG. 9, a mobile audio system 300 is shown using the power distribution block 216. Like the audio system 110, the audio system 300 includes a plurality of amplifiers 311 electrically connected to a battery 312, and a plurality of speakers 313. As shown, the power distribution block 216 replaces the power distribution block 116 shown in FIG. 6. The power distribution block 216 electrically connects the battery 312 to the amplifiers 311. This is done by electrically connecting the input terminals 220, 221 of the power distribution block 216 to the battery via a power cable 314 and a ground cable 315, and electrically connecting the output terminals 222, 223 of the power distribution block 216 to the amplifiers 311 via electrical cables 318. Each of the sense leads 226 are electrically connected to corresponding terminals between the power distribution block 216 and the battery 312 and the power distribution block 216 and the amplifiers 311. For example, the sense lead 226 electrically connected to the positive input terminal 220 is connected to a positive terminal of the battery 312.

As discussed above with reference to FIG. 4, the sense lead 226 determines the voltage drop between the source and the load. In this case, the sense leads 226 measure not only the voltage drop between the battery 312 and the power distribution block 216, but also the voltage drop between the power distribution block 216 and the amplifiers 311. If the voltage drop measured by the sense lead 226 exceeds a predetermined limit, the indicator 227 will provide a visual or audible indication that an undesired voltage drop exists.

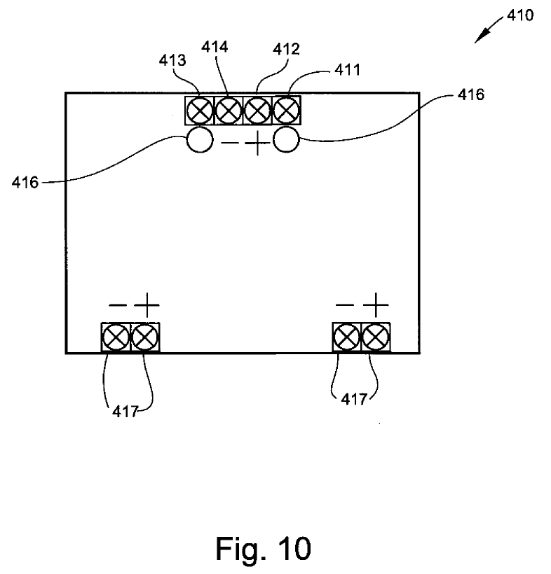

Referring to FIG. 10, an amplifier 410 according to a further embodiment of the invention may be used in any of the audio systems discussed above. The amplifier 410 includes a positive sense lead terminal 411 electrically connected to a positive input terminal 412, a negative sense lead terminal 413 electrically connected to a negative input terminal 414, voltage drop indicators 416 electrically connected to the sense lead terminals 411, 413 and input terminals 412, 414, and a plurality of speaker output terminals 417. The sense lead terminals 411 and 413 allow a sense lead to be electrically connected directly to the amplifier 410. This would allow a sense lead to be run directly from the amplifier 410 to a power source or to a chassis ground to monitor voltage drops and ground connections.

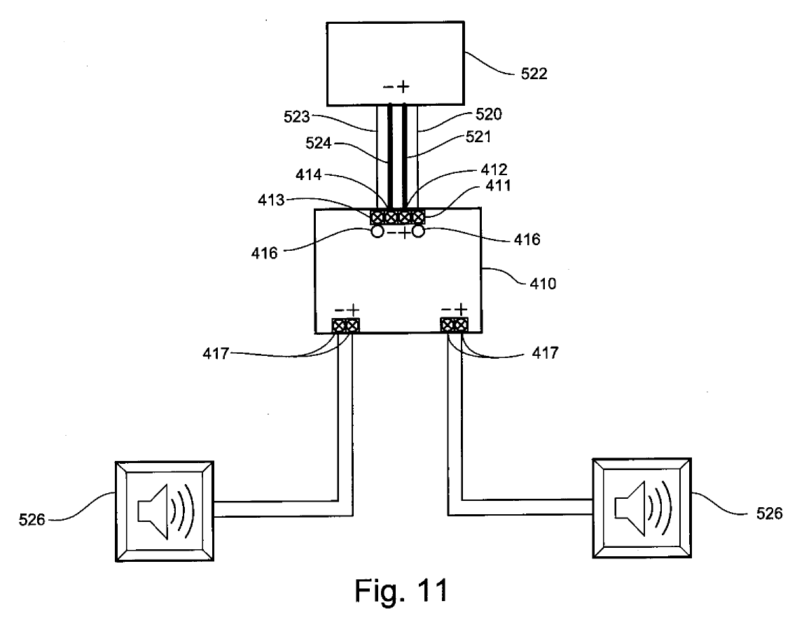

FIG. 11 illustrates a mobile audio system 500 using the amplifier 410. As shown, a sense lead 520 and power cable 521 are electrically connected to a positive terminal of a battery 522 and to the positive sense lead terminal 411 and positive input terminal 412 of the amplifier 410. Additionally, a sense lead 523 and ground cable 524 are electrically connected to a negative terminal of the battery 522 and the negative sense lead terminal 413 and negative input terminal 414. Speakers 526 are electrically connected to the speaker output terminals 417.

In a further embodiment of the invention, a reference voltage is used to compare the voltage coming into a power terminal of an amplifier. This can done by using a resistor with a zener diode having an 11 volt breakdown voltage or other reference source to determine whether the voltage from the battery is adequate to drive the amplifiers, thereby providing an indication as to whether an alternator is capable of providing enough voltage to the battery and the mobile audio system for proper operation.

An electrical apparatus with a voltage drop indicator is described above. Various details of the invention may be changed without departing from its scope. Furthermore, the foregoing description of the preferred embodiments of the invention and the best mode for practicing the invention are provided for the purpose of illustration only and not for the purpose of limitation.

I claim:

1. An electrical apparatus with voltage drop indication, comprising:
(a) a core for transmitting electrical current from a source to a load;
(b) a sense lead electrically connected to the core for sensing a voltage drop between a source end and a sink end of the core; and
(c) an indicator operably connected to the sense lead for providing an indication when the voltage drop exceeds a predetermined limit.

2. The electrical apparatus according to claim 1, wherein the sense lead includes a core for transmitting electrical current and an insulation layer for covering the core.

3. The electrical apparatus according to claim 1, wherein at least a portion of the sense lead is embedded in the core.

4. The electrical apparatus according to claim 1, wherein the indicator provides a visual indication of the undesired voltage drop.

5. The electrical apparatus according to claim 1, wherein the indicator provides an audible indication of the undesired voltage drop.

6. The electrical apparatus according to claim 1, wherein the indicator is a light emitting diode.

7. The electrical apparatus according to claim 1, wherein the indicator is located remote of the core.

8. The electrical apparatus according to claim 1, wherein the source end of the core is electrically connected to the source and the sink end is electrically connected to the load.

9. The electrical apparatus according to claim 8, wherein, when a voltage drop occurs between the source end and the sink end, current representative of the voltage drop is transmitted through the sense lead to the indicator.

10. The electrical apparatus according to claim 9, wherein, when the voltage drop reaches an undesired level the indicator activates to provide an indication of the voltage drop.

11. An electrical apparatus with voltage drop indication, comprising:
(a) at least one input terminal for being electrically connected to a source;
(b) at least one output terminal electrically connected to the at least one input terminal for being electrically connected to a load;
(c) at least one sense lead terminal electrically connected to a respective one of the input and output terminals for electrically connecting a sense lead carrying a current representative of a voltage drop; and
(d) at least one indicator operably connected to the at least one sense lead terminal for providing an indication when the voltage drop exceeds a predetermined limit.

12. The electrical apparatus according to claim 11, and further including a sense lead electrically connected to the at least one sense lead terminal for sensing a voltage drop and transmitting a current representative of the voltage drop to the at least one indicator.

13. The electrical apparatus according to claim 12, wherein the at least one indicator is attached to the at least one sense lead.

14. The electrical apparatus according to claim 11, wherein the at least one indicator is integrally-formed in the electrical apparatus.

15. The electrical apparatus according to claim 12, wherein the at least one sense lead is fixedly attached to the at least one sense lead terminal.

16. The electrical apparatus according to claim 12, wherein the at least one sense lead is electrically connected between the at least one sense lead terminal and the source to sense a voltage drop.

17. The electrical apparatus according to claim 16, wherein, when a voltage drop occurs between the source and the input terminal, current representative of the voltage drop is transmitted through the sense lead to the indicator.

18. The electrical apparatus according to claim 11, and further including at least one fuse electrically connecting the input terminal to the output terminal for providing a disconnect in the event of a surge.

19. An electrical apparatus with voltage drop indication, comprising:
(a) at least one input terminal for being electrically connected to a source;
(b) at least one output terminal electrically connected to the at least one input terminal for being electrically connected to a load;
(c) at least one indicator electrically connected to a respective one of the input and output terminals and fixedly attached to the electrical apparatus for providing an indication of a voltage drop exceeding a predetermined limit;
(d) at least one sense lead electrically connected to the indicator for sensing a voltage drop and transmitting a current representative of the voltage drop to the indicator.

20. The electrical apparatus according to claim 19, and further including at least one sense lead terminal for electrically connecting the at least one sense lead to a respective one of the input and output terminals.

21. The electrical apparatus according to claim 19, wherein the at least one sense lead is fixedly attached to a respective one of the input and output terminals.

22. The electrical apparatus according to claim 19, wherein the at least one sense lead is electrically connected between the at least one input terminal and the source to sense a voltage drop therebetween.

23. The electrical apparatus according to claim 19, wherein the at least one sense lead is electrically connected between the at least one output terminal and the load to sense a voltage drop therebetween.

24. An audio system, comprising:
(a) a power source;
(b) an amplifier electrically connected to the power source for amplifying a signal;
(c) a speaker electrically connected to the amplifier for receiving the signal and producing an audible sound; and
(d) an electrical apparatus for electrically connecting the power source to the amplifier, including:
(i) a core for transmitting current from the power source to the amplifier;
(ii) a sense lead at least partially embedded in the core for receiving a current representative of a voltage drop across the core;
(iii) an indicator electrically connected to the sense lead for receiving the current in the sense lead and providing an indication when the voltage drop exceeds a predetermined limit; and
(iv) an insulated cover for covering the core.

25. An audio system, comprising:
(a) a power source;
(b) an amplifier electrically connected to the power source for amplifying a signal, including:
(i) at least one input terminal for being electrically connected to the power source;
(ii) at least one output terminal electrically connected to the input terminal;
(iii) at least one sense lead terminal electrically connected to the input terminal;
(c) at least one speaker electrically connected to the at least one output terminal for receiving the signal therefrom; and
(d) a plurality of electrical cables for electrically connecting the power source to the at least one input terminal and the at least one output to the at least one speaker.

26. The audio system according to claim 25, wherein the amplifier includes at least one indicator electrically connected to the at least one input terminal for providing an indication of a voltage drop exceeding a predetermined limit.

27. The audio system according to claim 25, and further including a sense lead electrically connected between the power source and the at least one input terminal to detect a voltage drop in an electrical cable electrically connecting the power source to the at least one input terminal.

28. The audio system according to claim 26, and further including a sense lead electrically connected between the power source and the at least one sense lead terminal for transmitting a current representative of a voltage drop across an electrical cable electrically connecting the power source to the at least one input terminal.

29. The audio system according to clam 28, wherein the at least one indicator receives the current and provides an indication when the voltage drop exceeds a predetermined limit.

30. The audio system according to claim 25, and further including a plurality of amplifiers having:
(a) at least one input terminal for being electrically connected to the power source;
(b) at least one output terminal electrically connected to the input terminal; and
(c) at least one sense lead terminal electrically connected to the input terminal.

31. The audio system according to claim 30, and further including a power distribution block for distributing current from the power source to each of the plurality of amplifiers.

32. The audio system according to claim 31, wherein the power distribution block includes:
(a) at least one input terminal for electrically connecting to the power source; and
(b) a plurality of output terminals for electrically connecting to the plurality of amplifiers.

33. The audio system according to claim 33, wherein the power distribution block includes a sense lead for each of the input and output terminals to detect a voltage drop between the power source and the power distribution block and the power distribution block and the plurality of amplifiers.
